(19) United States
(12) Patent Application Publication
(10) Pub. No.: US 2007/0220811 A1
(43) Pub. Date: Sep. 27, 2007

(54) Door assembly with integrated window sealing system

(76) Inventors: Joseph Gustaaf Marie Flendrig, Brussels (BE); Jeffrey Valentage, Royal Oak, MI (US); Michael Schneider, Kuenzell (DE); Joachim Mueller, Alsfeld (DE); Gerhard Resch, Fulda (DE)

Correspondence Address: ExxonMobil Chemical Company;Law Technology, P.O. Box 2149, Baytown, TX, 77522-2149, US

(21) Appl. No.: 11/704,132

(22) Filed: Feb. 8, 2007

Related U.S. Application Data
(63) Continuation-in-part of application No. 11/590,307, filed on Oct. 31, 2006.
(60) Provisional application No. 60/785,039, filed on Mar. 23, 2006.

(51) Int. Cl. E05F 11/48

(52) U.S. Cl. 49/352

(57) ABSTRACT

This invention relates to a door system, comprising:
a door structure;
a body comprising one or more components disposed thereon;
a first module having an upper cavity and a lower cavity, the upper cavity adapted to at least partially surround a first side of a window glass and the lower cavity adapted to at least partially engage the body;
a second module adapted to at least partially surround a second side of the window glass and adapted to at least partially contact the upper cavity of the first module; and
a trim module adapted to at least partially cover the core module.

### CROSS REFERENCE TO RELATED APPLICATIONS

This application claims the benefit of and priority from U.S. Ser. No. 60/785,039, filed Mar. 23, 2006. This application is also a continuation-in-part of Ser. No. 11/590,307, filed Oct. 31, 2006. All of the above applications are fully incorporated herein by reference.

### BACKGROUND OF THE INVENTION

1. Field of the Invention

This invention relates to door systems. More particularly, embodiments of the present invention relate to door systems for vehicles, such as automobiles, specifically cars and trucks.

2. Description of the Related Art

Conventional doors for automobiles contain many individual pieces that are assembled to a frame or shell. Automotive doors can have more than fifty to greater than one hundred individual components or parts depending on the vehicle and option package. Such components can include various hardware, electrical components, and seals. Illustrative hardware components can include handles, mirrors, window regulators, window tracks, windows, door locks, and impact bolsters. Certain electrical components can include wire harnesses, speakers, window motors, and outside mirror motors. Illustrative sealing components include glass run channels, beltline seals, lower sash seals, plugs, grommets, and body to door seals.

Each component is typically supplied by a different vendor or supplier, some of which are known in the industry as Tier 1, Tier 2, and Tier 3 suppliers. In most cases, an original equipment manufacturer (OEM) produces a door frame and exterior skin that are typically stamped separately from cold rolled steel, welded together, and painted to provide a door shell. The frame and skin can possibly be stamped from one blank to form the door shell. The numerous individual components from the Tier 1, 2, and 3 suppliers are then assembled onto the OEM's door shell, typically at the OEM's assembly line.

The process of affixing the components to the door shell is time intensive and requires costly logistical considerations and/or systems to assure the right parts are at the right place at the right time. The assembly process can also demand a large amount of costly floor space. Each component is attached to the door shell using at least one of many different means including clips, screws, fittings, adhesives, just to name a few. In most cases, twenty to forty five different assembly steps are needed to complete the entire assembly process of the door.

FIG. 1 shows a schematic illustration of a conventional door 100. Typically, the door 100 has an interior trim panel 110, inner panel 120, intrusion beam 130, reinforcement section 140, and outer panel 150. Typically, the inner panel 120, intrusion beam 130, reinforcement section 140, and outer panel 150 are each formed from steel, stamped, welded together, and painted at the OEM. The numerous hardware, electrical and sealing components such as those listed above (not shown in FIG. 1 for simplicity) are typically assembled onto the steel inner panel 120 at the OEM. Similarly, the various components on the interior trim panel 110, including lights, switches, armrests, map pockets, handles, etc., (also not shown for simplicity) are assembled at a Tier supplier and shipped to the OEM. The OEM attaches the assembled trim panel 110 to the assembled inner panel 120, and the final electrical and hardware connections are made.

Accordingly, the door manufacturing process is intensive and time consuming. The assembly process also requires a high degree of logistical planning to ensure all the parts are available and assembled in the correct manner and order. Other incidental and related costs include ordering, storage, management, transportation, functionality testing, quality control, in addition to the floor space to assemble the various components. All those factors add up to a very costly end product.

Initial cost savings and part consolidation ideas have tried using pre-assembled mounting panels with all or part of the hardware and electrical components assembled thereto as shown in FIG. 2. FIG. 2 shows a schematic illustration of a conventional door 200 having a pre-assembled mounting panel 210. Numerous components are assembled to the mounting panel 210, including an interior door handle 215, handle linking cables 220, window motor 225, window regulator 230, speaker 235, window guide rail 240, drum pulley 245, cable 250, and door lock unit 260.

All or part of the hardware and electrical components can be installed onto the mounting panel 210 at an outside supplier, such as a Tier 1 supplier. The mounting panel 210 is typically made from stamped steel, thermoformed glass mat reinforced thermoplastic (GMT), or injection molded long glass fiber reinforced polypropylene. Once the applicable components are assembled onto the mounting panel 210 at the outside supplier, the assembled mounting panel 210 is transported to the OEM for installation on a door panel sub-assembly or outer panel 270. An interior trim panel 280 is then attached to the outer panel 270. Other part consolidation ideas are described in U.S. Pat. Nos. 6,857,688; 6,640,500; 6,546,674; 6,449,907; 5,820,191; 5,355,629; 5,040,335; 4,882,842; 4,648,208; and WO 01/25055 A1.

Several examples of pre-assembled mounting panels are believed to be in production. However, the number of components and the required assembly time has remained largely unchanged. The cost benefits to the OEM are mainly due to logistical cost savings absorbed by the Tier suppliers.

There is a need, therefore, for a door assembly having fewer individual components. There is also a need for a door assembly that minimizes the number of individual components requiring assembly.

### SUMMARY OF THE INVENTION

This invention relates to a door system, comprising:

a) a door structure;
b) a body comprising one or more components disposed thereon;
c) a first module having an upper cavity and a lower cavity, the upper cavity adapted to at least partially surround a first side of a window glass and the lower cavity adapted to at least partially engage the body;
d) a second module adapted to at least partially surround a second side of the window glass and adapted to at least partially contact the upper cavity of the first module; and
e) a trim module adapted to at least partially cover the core module.

### BRIEF DESCRIPTION OF THE DRAWINGS

FIG. 1 is a schematic illustration of a conventional door as used in the prior art.

FIG. 2 is a schematic illustration of a conventional door having a pre-assembled mounting panel as used in the prior art.

FIG. 3 is a schematic view of one illustrative embodiment of an integrated door system according to one or more embodiments described.

FIG. 4 is a schematic view of one illustrative embodiment of a door structure in accordance with one or more embodiments described.

FIG. 5A is a schematic view of one illustrative embodiment of an outer core module in accordance with one or more embodiments described.

FIG. 5B is an enlarged, cross sectional view of the glass run channel 350 along lines A-A of FIG. 5A.

FIG. 6 is a schematic view of a first side of an illustrative core module in accordance with one or more embodiments described.

FIG. 7 is a schematic view of a second side of the core module shown in FIG. 6, which is an illustrative core module in accordance with one or more embodiments described.

FIG. 8A is a schematic view of one illustrative embodiment of a window trim module in accordance with one or more embodiments described.

FIG. 8B is an enlarged, cross sectional view of the window trim module along lines B-B of FIG. 8A.

FIG. 8C is an enlarged, cross sectional view of the window trim module along lines C-C of FIG. 8A.

FIG. 9 is a schematic view of an illustrative reinforcement member in accordance with one or more embodiments described.

FIG. 10 is a schematic plan view of an illustrative reinforcement member having a cover plate attached thereto.

FIG. 11 is a cross section of an illustrative reinforcement member with one or more clips to secure a cover plate thereon.

FIG. 12 is a partial cross section of an illustrative reinforcement member having a profiled edge of protrusion formed thereon.

FIG. 13 is a schematic view of an illustrative reinforcement member having one or more stiffening structures disposed thereon.

FIG. 14 is a schematic view of an illustrative reinforcement member having one or more stiffening structures disposed thereon, the stiffening structures having a diamond shaped pattern.

FIG. 15 is a schematic view of an illustrative reinforcement member having one or more stiffening structures disposed thereon, the stiffening structures having a honeycomb shaped pattern.

FIG. 16 is a schematic view of a reinforcement member having one or more depressions for attaching to an insert in accordance with one or more embodiments described.

FIG. 17 is a schematic view of a reinforcement member having one or more apertures for attaching to an insert in accordance with one or more embodiments described.

FIG. 18 is an enlarged, schematic view of a reinforcement member having one or more slits or openings for attaching to an insert in accordance with one or more embodiments described.

FIG. 19 is an enlarged, partial cross section of a reinforcement member having one or more clips disposed thereon for engaging and holding a cover plate in accordance with one or more embodiments described.

FIG. 20 is a schematic of an illustrative cover plate having one or more clips formed thereon for securing to a reinforcement member in accordance with one or more embodiments described.

FIG. 21 is a schematic of one embodiment of a window lift system in accordance with one or more embodiments described.

FIG. 22 is an enlarged, partial cross sectional view of the motor housing shown in FIG. 21.

FIG. 23 is an enlarged, partial cross section of the window track shown in FIG. 21.

FIG. 24 is a schematic of another embodiment of a window lift system in accordance with one or more embodiments described.

FIG. 25 is an enlarged, partial cross sectional view of the motor housing shown in FIG. 24.

FIG. 26 is an enlarged, partial cross section of the window track shown in FIG. 24.

FIG. 27 is a schematic side view of one embodiment of an illustrative lock assembly having a sliding mechanism for assembly, the sliding mechanism located in a pre-assembled position.

FIG. 28 is a schematic side view of the sliding mechanism shown in FIG. 27, the sliding mechanism located in an assembled position.

FIG. 29 is an enlarged partial cross section of the sliding mechanism shown in FIG. 28 along lines A-A.

FIG. 30 is a schematic side view of another embodiment of an illustrative lock assembly having a sliding mechanism for assembly, the sliding mechanism located in a pre-assembled position.

FIG. 31 is a schematic side view of the sliding mechanism shown in FIG. 30, the sliding mechanism located in an assembled position.

FIG. 32 is an enlarged, partial cross section of the sliding mechanism shown in FIG. 31 along lines A-A.

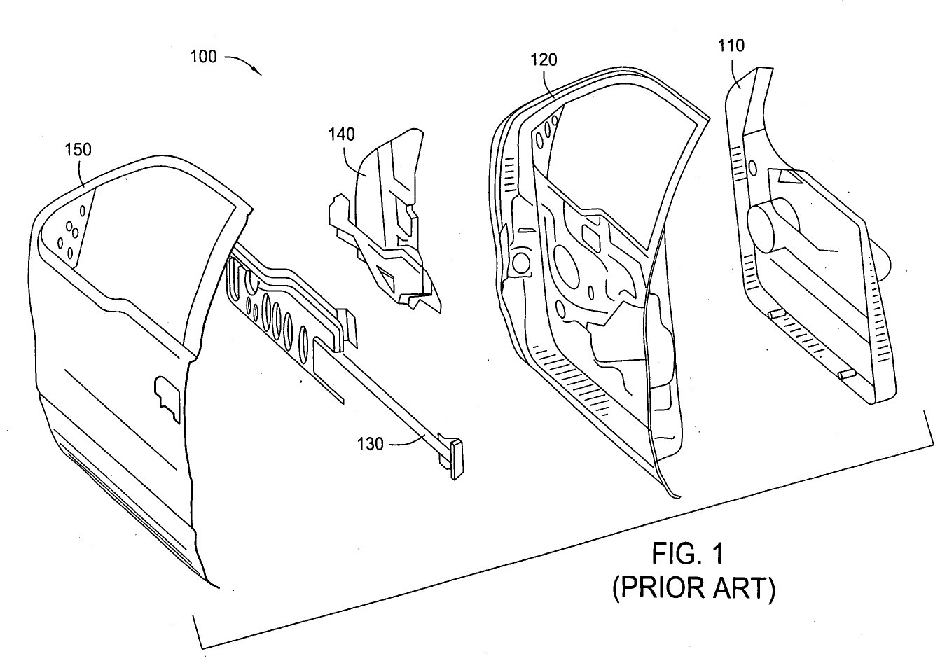

### DETAILED DESCRIPTION OF THE INVENTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information is combined with available information and technology.

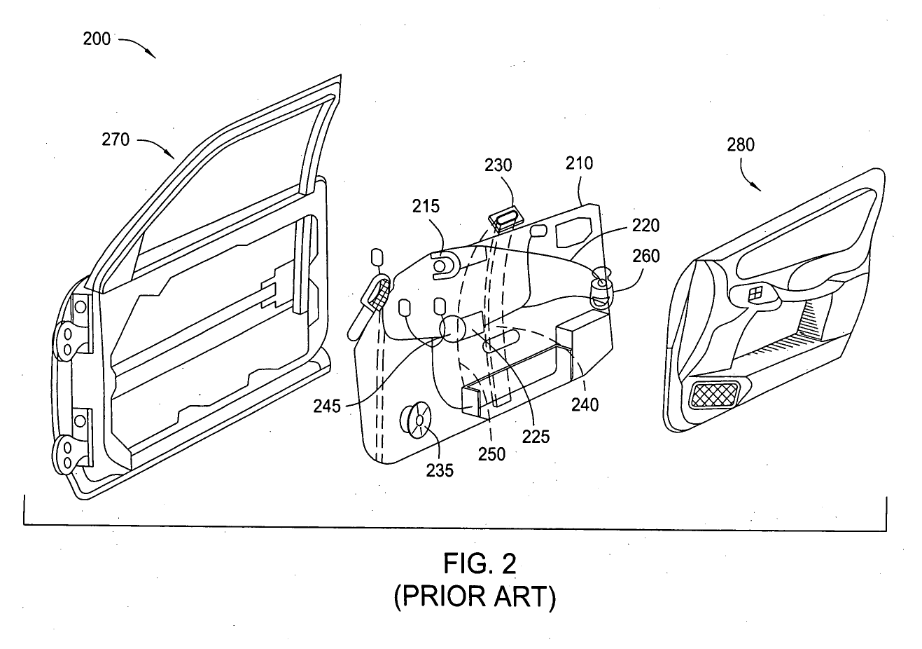

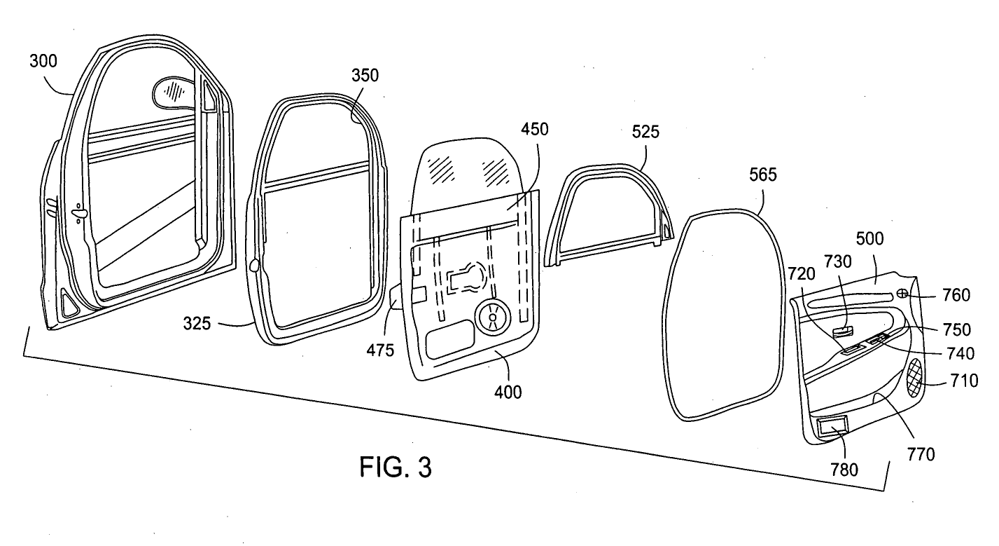

FIG. 3 shows a schematic view of an illustrative door system according to one or more embodiments herein. In at least one specific embodiment, the door system includes a door structure 300, outer core module 325, core module 400, window trim module 525 and trim panel 700. The outer core module 325 is a frame structure that assembles to the door structure 300. The window trim module 525 resembles the shape of a conventional upper window surround and assembles to the outer core module 325 and an upper portion of the core module 400. In other words, the core module 400 assembles to the outer core module 325 and beneath the window trim module 525. The trim panel 700 covers the core module 400 and completes the assembly of the door system.

Preferably, the door system utilizes multi-material injection molding technology or robotic extrusion to integrate the various components. Multi-material injection molding techniques allow two or more materials to be injection molded into a single or multiple cavity mold. A two component or material process is commonly known as “2K” and a three material process is commonly known as “3K.” Any suitable multi-material injection molding machine can be used, such as an Engel Victory Combi machine available from Engel Corp. Additional in-mold processing techniques can also be used to enhance and/or facilitate the integration. Illustrative in-mold processing techniques include, but are not limited to, multiple cavity tools, insert molding, movable core sections, and gas/water assist. Robotic extrusion can also be used alone or in combination with any of these processing techniques. Robotic extrusion is particularly useful for applying the sealing members or other functional parts onto the already injection molded structure. With this system it is also possible to create hollow seal cross-sections if required.

As used herein the term “door” is intended to include any door. For example, the term “door” can refer to one or more passenger doors, whether hinged, sliding, lifting or with any other alternative opening/closing movement, lift gates, tail gates, and hatchbacks for any vehicle including cars, trucks, SUVs, trains, boats, airplanes, etc., whether for personal, recreational, military or commercial use.

Each of the substrates 300, 350, 400, 525, 700 can include one or more seals, plugs, and/or grommets. Preferably, the one or more seals, plugs, and grommets are injection molded on the substrate. Any one or more of the seals, plugs, and grommets can be directly molded on the substrate using two or three shot injection molding or robotic extrusion techniques. The integrated seals, plugs, and grommets help prevent or eliminate water seepage, rattles and vibration. Such components also increase the acoustical performance of the part (i.e., provide sound insulation and the “closing sound” of the door) while compensating for differences in part tolerance and expansion while allowing some movement.

As shown in FIG. 3, the trim panel 700 can further include one or more speaker covers 710, arm rests 720, door handle 730, window switches 740, door lock switches 750, side mirror controls 760, map pockets 770, and interior lights 780. The trim panel 700 can provide a housing or substrate for other electrical, mechanical and sealing components to be attached or integrally molded, or insert molded thereto. Illustrative components include, but are not limited to, air bags, air vents, switches; door handles; door locks; arm rests; map pockets; speaker covers or grilles; speakers; beltline seals; plugs; grommets; and core to frame seals. Illustrative switches include window glass controls, window locks, outside mirror positioning controls, door locks, seat positioning controls, and stereo controls.

Preferably, the trim panel 700 is injection molded from one or more materials, such as polyethylene, polypropylene and/or one or more other suitable materials described herein. In one or more embodiments, the arm rest 720, speaker cover 710, and map pocket 770 are injection molded on the trim panel 700 using multi-material or multi-shot injection molding techniques. Each of the trim panel 700, arm rest 720, speaker cover 710, and map pocket 770 can be injection molded from the same or different one or more materials, including polyethylene, polypropylene and/or one or more other suitable materials described herein.

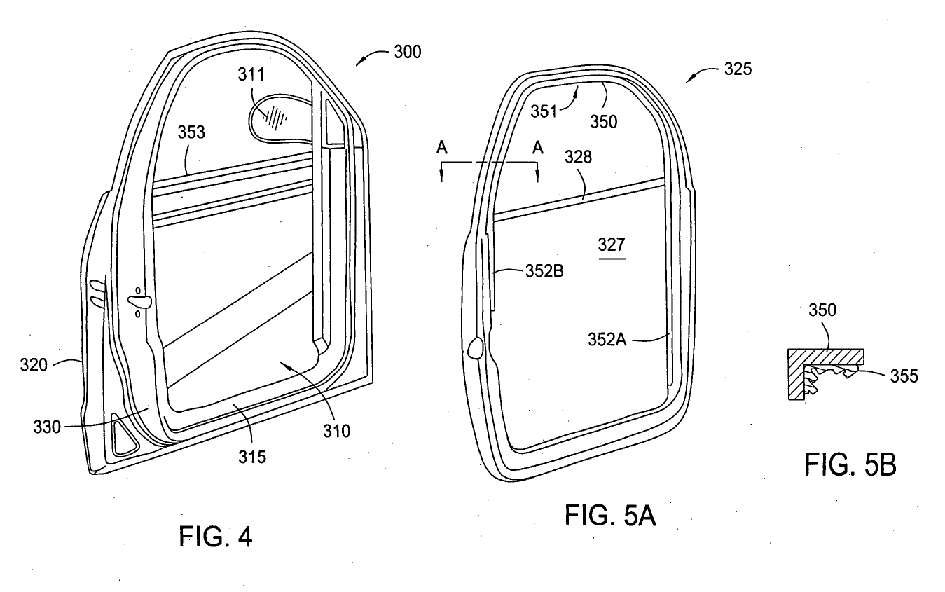

Considering the door structure 300 in more detail, FIG. 4 shows a schematic plan view of one embodiment. The door structure 300 can be fabricated from one or more separate panels. For example, the door structure 300 can include an outer skin 320 and an inner support 330 affixed to one another. Each of the outer skin 320 and the inner support 330 can be injection molded from polyethylene or polypropylene and more preferably from a reinforced polypropylene. In certain embodiments, each of the outer skin 320 and the inner support 330 can be injection molded, cast, extruded, molded or formed in an other way from one or more other suitable materials, such as the materials discussed herein. In one or more embodiments, each of the outer skin 320 and the inner support 330, can be stamped from aluminum or cold, rolled steel, assembled, and painted to meet the specifications of the OEM. In one or more embodiments, each of the outer skin 320 and the inner support 330 can be made from different types of steel (i.e., “tailored blanks”), welded together stamped and painted as desired. Furthermore, the door structure 300 can be a single component or single panel.

The door structure 300 has a first side or interior side 310 that faces the passenger compartment of the vehicle. The interior side 310 of the door structure 300 can include a recessed cavity 315 that is sized and shaped to resemble the dimensions of the core module 400 such that when assembled, at least a portion of the core module 400 fits into the recessed cavity 315 of the door structure 300. In one or more embodiments, the core module 400 includes a perimeter seal (not shown in this view) that can be integrally formed therewith or attached separately. That seal creates a wet/dry barrier between the door structure 300 and the outer core module 325, helps to create a rattle free assembly, helps to reduce noise transmission, and helps compensate for thermal expansion, among other purposes and benefits. The door structure 300 also has a second side or exterior side (not shown in this view) to which a side mirror 311 and external door handle (also not shown in this view) can be attached. As used herein, the term “interior” refers to an orientation or direction facing toward the passenger compartment or inside of the vehicle, and the term “exterior” refers to an orientation or direction facing away from the passenger compartment or inside of the vehicle.

In one or more embodiments above or elsewhere herein, the door structure 300 does not have a reinforcement structure or member located at or near the beltline 353. The absence of a reinforcement structure or member allows greater access to the window glass and other components that require assembly or repair. In particular, the absence of such an obstruction at the beltline 353 makes the window glass assembly and disassembly very easy as explained in more detail below. The absence of a reinforcement structure or member also reduces the overall weight of the door assembly, which leads to lighter vehicles and better gas mileage.

FIG. 5A is a schematic view of one illustrative embodiment of the outer core module 325 in accordance with one or more embodiments described. The outer core module 325 is a frame structure having an upper cavity 326 and a lower cavity 327. The two cavities 326, 327 are separated by a support member 328 at about the beltline. One or more seals can be easily integrated with the outer core module 325 providing increased noise reduction and improved water leakage resistance.

The outer core module 325 includes a glass run channel 350. At least a portion of the glass run channel 350 is disposed within the upper cavity 326 and at least a portion of the glass run channel 350 is disposed within the lower cavity 327 of the outer core module 325 as shown in FIG. 5A. In one or more embodiments, the glass run channel 350 has an upper portion 351 disposed within the upper cavity 326 of the outer core module 325 and one or more lower portions 352 disposed within the lower cavity 327. For example, a first portion 352A of the glass run channel 350 is attached to the outer core module 325 below the belt line support 328 along the A pillar side of the outer core module 325, and a second portion 352B of the glass run channel 350 is attached below the belt line support 328 along the B pillar side of the outer core module 325. Preferably, at least one of the first and second portions 352A, 352B of the glass run channel 350 has enough length to contact the window glass when the window glass is in a lowered position. More preferably, both the first and second portions 352A, 352B of the glass run channel 350 have a sufficient length to contact the window glass when the window glass is in a lowered position.

The glass run channel 350 can be made from one or more separate sections or members that are fitted, welded, or otherwise attached together or kept in a fixed orientation relative to each other. Preferably, the glass run channel 350 is made from a single member. Alternatively, the portions or sections 351, 352A, and 352B can each be a separate piece or make up two or more pieces. In one or more embodiments, the glass run channel 350 has one or more cross sections (i.e., profiles) adapted to contact the window glass. Illustrative profiles include “U” shaped, “L” shaped, and combinations thereof, either alone in combination with one or more lips, bulbs, or other sealing elements.

FIG. 5B shows an enlarged, cross sectional view of the glass run channel 350 along lines A-A of FIG. 5A. In one ore more embodiments, the upper portion 351 of the glass run channel 350 has an open or “L” shaped profile 355 that can contact an outer edge of the window glass (not shown). As will be explained in more detail below, the window trim module 525 can have a matching profile (e.g., open or “L” shaped profile) that contacts an outer edge of the window glass so that the window glass is squeezed and sealed therebetween.

Still referring to FIG. 5B, the A pillar side of the lower portion 352A preferably has an “L” shaped profile 355 as does the B pillar side of the lower portion 352B. The “L” shaped profile 355 contacts the outer (i.e., exterior) perimeter of the window glass. As will be explained in more detail below, the core module 400 can include a complementary shaped profile (i.e., open or “L shaped” profile) to contact the inner (i.e., interior) perimeter of the window glass so that the matched profiles guide the window glass when assembled. Such sealing system is similar to how the opposing profiles (i.e., seals) on the window trim module 325 and the upper portion 351 of the glass run channel 350 each work together to form a seal at the upper portion of the window glass.

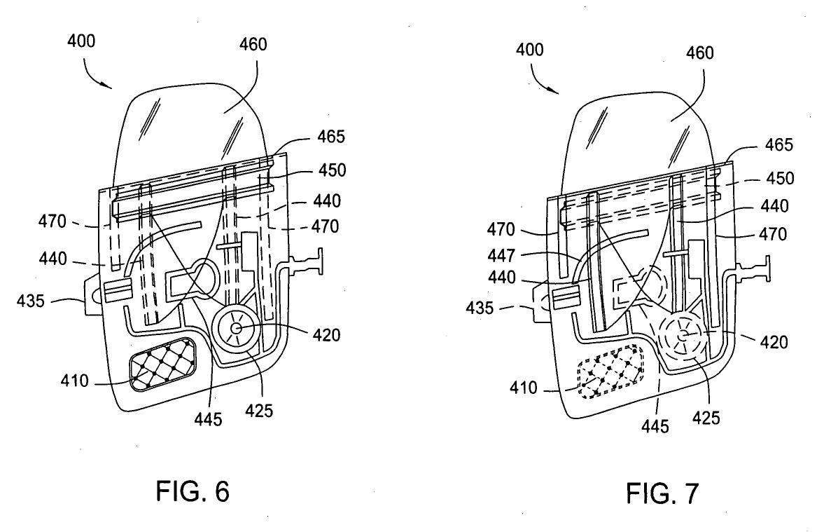

Considering the core module 400 in more detail, FIG. 6 is a schematic view of an illustrative core module 400 according to one or more embodiments herein. As mentioned above, the core module 400 includes one or more hardware components, electrical components and sealing members (i.e., “seals”). Illustrative components assembled to the core module 400 include, but are not limited to window regulators; motors; tracks; impact bolsters; wire harnesses; speaker boxes or receptacles; speakers; window motors; outside mirror motors; beltline seals; plugs; grommets; and core to frame seals. For simplicity and ease of illustration, however, the core module 400 is shown in FIG. 6 having one or more bolsters or crash pads 410, speaker boxes 425, window tracks 440, motor supports 445, window glass 460, belt line seals 465, and glass run channels 470. It is to be understood that the core module 400 can include any other component typical of an automotive door. For example, the core module 400 can include one or more speakers 420, door control units 430, door locks 435, and cable locks 447. The core module 400 can also include one or more air distribution channels for heating or air (not shown).

Preferably, the individual components are injection molded on the core module 400. For example, the one or more bolsters 410, speaker boxes 425, window tracks 440, motor support 445, reinforcement section 450, belt line seal 465, and air distribution channels (not shown) can be integrally formed with the core module 400 using multi-material or multi-shot injection molding techniques. As such, assembly time is greatly reduced since the components are an integral part of the core module 400, and not a separate component requiring costly assembly.

The side bolsters 410 can be foamed members, such as foam blocks. The side bolsters 410 can also be hollow structures. Preferably, the bolsters 410 are injection molded using a stiff material. The bolsters 410 can be injection molded of the same material as the core module 400 or the bolsters 410 can be second shot molded onto the core module 400 using multi-injection molding techniques.

In one or more embodiments, the core module 400 further includes a reinforcement member 450. The reinforcement member 450 adds strength and stiffness to the core module 400 and the overall door system when assembled. Conventional doors have a reinforcement bar attached onto the door frame, as discussed above. In the embodiment shown in FIG. 6, the core module 400 and the reinforcement member 450 are integrally formed thereby reducing the number of components of the door and/or assembled to the core module 400 to facilitate installation and functionality testing of the door assembly, especially the window lift system. The reinforcement member 450 can be disposed on either the interior side (“first side”) of the core module 400 or the exterior side (“second side”) of the core module 400. The reinforcement member 450 is shown on the interior side of the core module 400 in FIG. 6.

Considering the reinforcement member 450 in more detail, the reinforcement member 450 can be a bar or plate or any other structure that adds strength to the door system. Preferably, the reinforcement member 450 has a length longer than the width and thickness thereof resembling a bar or plate, and is located proximate or adjacent the beltline of the door. The reinforcement member 450 can be fabricated from a separate component and assembled onto the core module or the reinforcement member can be insert-molded with the core module 400. In one or more embodiments, the reinforcement member 450 and the core module 400 are made from the same material or the same combination of materials. In one or more embodiments, the reinforcement member 450 and the core module 400 are made from different materials or a different combination of materials. Moreover, the reinforcement member 450 can be stamped from steel or aluminum, or fabricated from one or more non-metallic materials such as polyethylene, polypropylene or one or more other materials discussed herein. Preferably, the reinforcement member 450 is injection molded in a two component process (“2K process”) with the core module 400. More preferably, the reinforcement member 450 is stamped from aluminum, steel, or other suitable metal or alloy, and inserted into the injection molding tool and at least partially over-molded with the core module 400 material.

FIG. 7 shows a schematic view of one or more components of the core module 400 disposed on the second side or exterior side thereof. The glass run channel 470 is preferably 2K molded on the second side of the core module 400 using a multi-material injection molding machine. The second material is preferably a slip coating to reduce friction with the window glass or the surface friction of the second material can be low enough to allow the glass to slide along it with acceptable force. Alternatively, the glass run channel 470 can be a separate member attached or otherwise assembled onto the core module 400.

The glass run channel 470 can have one or more profiles, such as “U” shaped, “L” shaped, or any combinations thereof, either alone in combination with one or more lips, bulbs, or other sealing elements. As mentioned, the glass run channel 470 preferably has a shaped profile or at least one lip to match the “L” shaped profile of the lower portion 352A of the glass run channel 350 on the outer core module 325, as shown in FIGS. 5A and 5B. As such, when the core module 400 is attached to the outer core module 325, the mating profiles of the glass run channels 470 and 352 provide a shaped guide for the window glass 460 to travel.

Still referring to FIG. 7, the one or more window tracks 440 are preferably located on the second side of the core module 400. As mentioned above, the one or more window tracks 440 can be integrated with the core module 400. Preferably, the window tracks 440 are injection molded on the core module 400. A slip coating can be inserted into the mold where the window tracks 440 are formed to reduce friction with the window glass. This can be done using the 2K or multi-material injection techniques or robotic extrusion. Alternatively, the slip coat can be inserted in the tool before the tracks 440 are molded. This can be done, for example, as a coating on a thin polymeric film. Alternatively a thin polymeric film with a flock coating can be inserted into the tool and overmolded. The slip coating is preferably made of a material that can reduce friction between the window tracks 440 and the window glass. The slip coating can be made of polyethylene, polypropylene or other suitable materials, including the materials discussed herein. If the coefficient of friction of the base material from which the seal is made is low enough, it is no longer necessary to add a low friction surface to the seal.

The belt line reinforcement integration (i.e., reinforcement member 450) and the integration of the glass run channel 470 onto the core module 400 can allow the complete pre-installation of the window lift system including the window glass 460 as shown in FIG. 6. The use of the inner and outer core module allow the complete integration and pre-testing of the complete glass run channel into the door module. Fewer parts have to be supplied to the assembly line, fewer parts need to be assembled at the assembly line. As such, the window mechanism and controls can be tested at the Tier 1 supplier of the assembler of the core module 400, thereby reducing the time and costs of the OEM's assembly. In order to ensure the correct functioning of the glass run channel many glass run channels consist of several extruded profiles of different shapes that are interconnected by a corner molding and/or connected to an end molding or by welding or bonding. Any deviation from the extruded 2-dimensional shape of the profiles can be created in a post processing step.

If a (multi-material) injection molded seal is used, the geometry of the seal can be designed much more freely. Using injection molding it is possible to change the number of or the angle of the individual sealing lips over the length of the seal. In this way, improvement in sealing properties (against moisture, sound or airflow) can be enhanced without the added costs of local over molding of seals.

The corner moldings and end moldings also serve an aesthetic function. The injection molded seals offer freedom in design and allow aesthetically pleasing profiles. The surface of the injected seals can be smooth. The surface of the injected seals can also be grained or covered with a flocked material or low friction coating. A thermoplastic material (e.g., polypropylene) can also allow different colors for the profile. These colors can be changed quickly in the injection molding process and if multiple machines are used it is possible to have different colors in one seal.

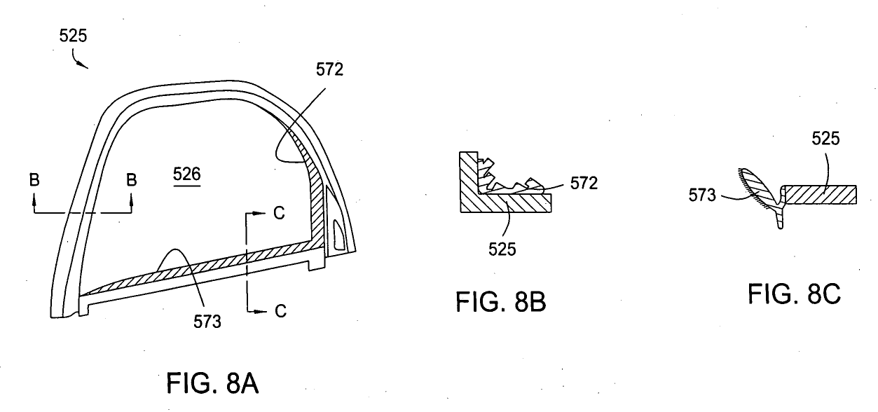

Considering the window trim module 525 in more detail, FIG. 8A shows a schematic view of one illustrative embodiment. FIG. 8B shows an enlarged, cross sectional view of the window trim module 525 along lines B-B of FIG. 8A. Referring to FIGS. 8A and 8B, the window trim module 525 is also a framed structure having an opening or cavity defined therein 525A. The window trim module 525 includes a glass run channel 572 disposed on a second or exterior side thereof. The glass run channel 572 can have one or more profiles, such as “U” shaped, “L” shaped, or any combinations thereof, either alone in combination with one or more lips, bulbs, or other sealing elements. Preferably, the glass run channel 572 has a shaped profile or at least one lip such as profile 355 shown in FIG. 5B to match the open or “L” shaped profile of the upper portion 351 of the glass run channel 350 of the outer core module 325 that is shown in FIGS. 5A and 5B. As such, when the window trim module 525 is attached to the outer core module 325, the mating profiles of the glass run channels 572 and 351 provide a sealed guide for the window glass to travel.

In one or more embodiments above or elsewhere herein, the window trim module 525 further includes an inner belt line seal 573 integrally formed thereon. FIG. 8C shows an enlarged, cross sectional view of the inner belt line seal 573 along lines C-C of FIG. 8A. The inner belt line seal 573 is preferably 2K molded on the second side of the outer core module 525 using a multi-material injection molding machine. The second material is preferably a flocked or slip coating to reduce friction with the window glass or the surface friction of the second material can be low enough to allow the glass to slide along it with acceptable force. Alternatively, the inner belt line seal 573 can be a separate member attached or otherwise assembled onto the outer core module 525. The inner belt line seal 573 can also be integrated into the inner core module 525 depending on the desired applications.

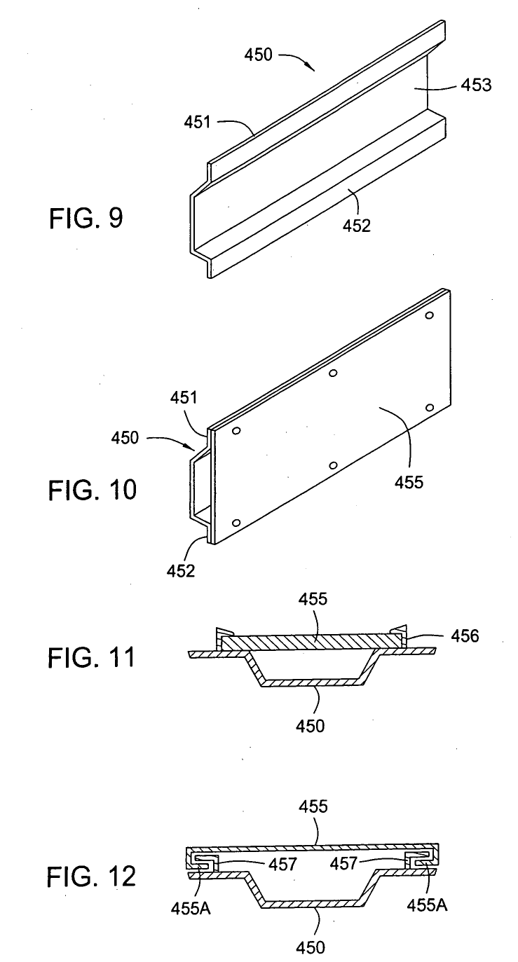

FIG. 9 is a schematic view of an illustrative reinforcement member 450 that can be used. The reinforcement member 450 can include a top flange 451 and a bottom flange 452 for assembly to the core module 400 (not shown in this view). Also not shown in this view, each flange 451, 452 can include one or more apertures to receive one or more fastening member, such as a clip, screw, bolt, rivet, etc. In one or more embodiments, the reinforcement member 450 can include a recessed section 453 located between the flanges 451, 452, as shown in FIG. 9. The recessed section 453 can have any depth whether constant or variable. The primary purpose of that depth is to provide stiffness (i.e., resistance against deformation). The depth can be, for example, between 0.05 inches and 8 inches, between 1 inch and 6 inches, or between 0.5 inches and 3 inches, depending on the vehicle make.

In one or more embodiments above or elsewhere herein, the reinforcement member 450 can include a cover plate 455 disposed thereon to provide added strength and stiffness, as shown in FIG. 10. FIG. 10 shows a schematic plan view of the reinforcement member 450 having the cover plate 455 attached thereto. The cover plate 455 is preferably secured to the reinforcement member 450 at the top and bottom flanges 451, 452. The cover plate 455 can be attached to the reinforcement member 450 using adhesion or any mechanical fastener including, for example, screws, bolts, rivets, clips, etc. The cover plate 455 can also be spot welded to the reinforcement member 450.

In one or more embodiments above or elsewhere herein, the cover plate 455 can be attached to the reinforcement member 450 using one or more clips 456 as shown in FIG. 11. FIG. 11 shows a schematic cross sectional view of the reinforcement member 450 with one or more clips 456 to hold the cover plate 455 thereon. Preferably, the one or more clips 456 are injection molded or integrally formed with the reinforcement member 450 although the one or more clips 456 can be easily attached during assembly.

In one or more embodiments above or elsewhere herein, the cover plate 455 can slide onto the reinforcement member 450. For example, the cover plate 455 can include a profiled edge adapted to slide across a mating profiled edge of the reinforcement member 450, as shown in FIG. 12. FIG. 12 shows a partial cross section of the reinforcement member 450 and cover plate 455 having profiled edges adapted to engage and slide thereabout. The profiled protrusion 457 of the reinforcement member 450 engages the profiled edge 455A of the cover plate 455, serving as a rail or guide for which the cover plate 455 can slide. Preferably, the clearance between the profiled edge 455A of the cover plate 455 and the profiled protrusion 457 of the reinforcement member 450 is just enough for the cover plate 455 to slide into place and held in place without later vibrating or rattling during use.

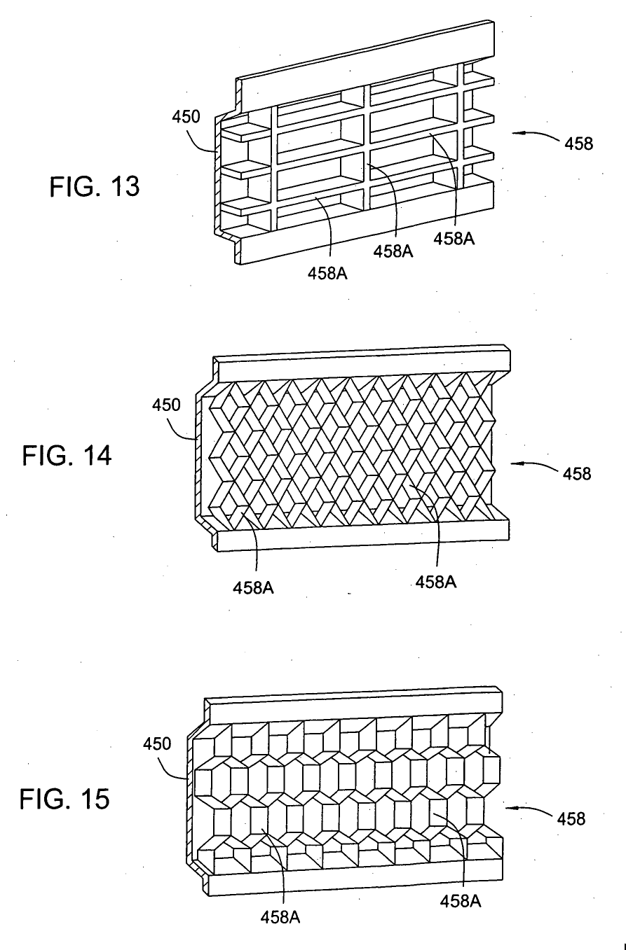

In one or more embodiments above or elsewhere herein, the reinforcement member 450 can include an insert or stiffening structure 458 disposed within the recessed section 453 as shown in FIG. 13. FIG. 13 is a schematic view of an illustrative reinforcement member 450 having one or more inserts 458. Preferably, the insert 458 includes one or more fingers or ribs 458A that can be formed by over-molding a plastic structure within the recessed section 453 of the reinforcement member 450. The insert 458 increases resistance against deformation. The insert 458 can provide significantly higher energy absorption and resistance against buckling. After over-molding the insert 458, the cover plate 455 can be disposed thereon as explained above with reference to FIGS. 10-12, to provide additional strength.

In one or more embodiments above or elsewhere herein, the ribs 458A of the insert 458 can be arranged in various patterns as shown in FIGS. 13, 14 and 15. For example, the ribs 458A can have a rectangular pattern to resemble a checker board, as shown in FIG. 13. In one or more embodiments, the ribs 458A can have a diamond pattern, as shown in FIG. 14. In one or more embodiments, the ribs 458A can have a honeycomb or polygonal pattern, as shown in FIG. 15. Other patterns include tubulars and circles and depend on the stiffness and strength desired for the application and design considerations.

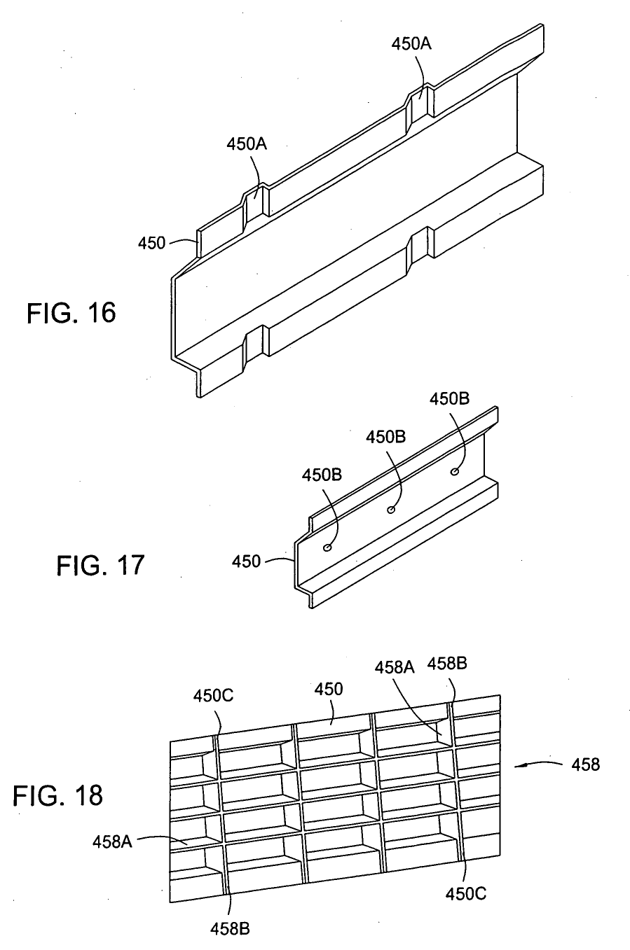

In one or more embodiments above or elsewhere herein, the insert 458 can be disposed within or otherwise attached to the recessed section 453 of the reinforcement member 450 using a variety of techniques, such as those shown in FIGS. 16-18. FIGS. 16, 17, and 18 each show schematic views of the reinforcement member 450 having various ways to retain or hold the insert 458. For example, the reinforcement member 450 can include one or more recesses or depressions 450A to provide a location or anchor for at least a portion of the insert 458, as shown in FIG. 16. Accordingly, the insert 458 can include a mating protrusion (not shown) to fit within the depressions 450A of the reinforcement member 450, and contact the main body of the core module 400. As such, the insert 458 can be held in place during assembly. If the optional cover plate 455 is used, the insert 458 can be held in place with the depressions 450A until the cover plate 455 is secured into place.

In one or more embodiments above or elsewhere herein, one or more apertures 450B can be formed within the recessed section 453 of the reinforcement member 450, as shown in FIG. 17. During the over-molding injection process the apertures 450B allow the material of the insert 458 to flow through the reinforcement member 450. As such, the material of the insert 458 is anchored within the reinforcement member 450 and secured in place.

In one or more embodiments above or elsewhere herein, the reinforcement member 450 can include one or more slits or openings 450C to receive a protruding feature 458B of the insert 458, as shown in FIG. 18. The protruding feature 458B of the insert 458 can simply be an extension of one or more ribs 458A. The one or more slits 450C of the reinforcement member 450 can be biased or otherwise designed to provide a friction fit to hold the insert 458 in place.

In any of the embodiments described above with reference to FIGS. 16, 17 and 18, the insert 458 can be held into place on the reinforcement section 450 and be ready for use. Alternatively, the insert 458 can be held into place on the reinforcement section 450 for such length of time to allow a bonding adhesive of the cover plate 455 to reach sufficient strength, thereby relying on the cover plate 455 to hold the insert 458 in place during use. Further, the embodiments described allow the insert 458 to be held into place on the reinforcement section 450 for such length of time to allow the cover plate 455 to be mechanically fastened to the reinforcement member 450 or the core module 400. Suitable mechanical fasteners include clip screws, heat stakes, rivets, blind rivets, and bolts, just to name a few. Spot welding can also be used.

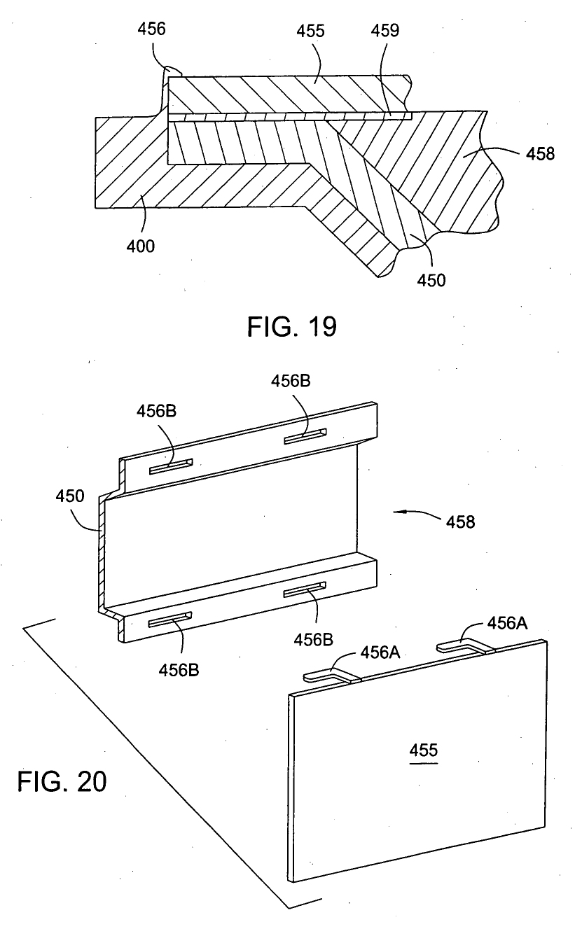

Preferably, the cover plate 455 and the reinforcement member 450 are clipped to one another. For example, FIG. 19 shows an enlarged, partial cross sectional view of the reinforcement member 450 having one or more clips 456 disposed thereon for engaging and holding the cover plate 455 in place. The clips 456 can be simply designed to contact the back side of the cover plate 455 thereby holding the cover plate 455. In one or more embodiments above or elsewhere herein, a layer of adhesive 459 can be used to hold the cover plate 455 in place. The clips 456, therefore, could be designed to have just enough structural integrity to hold the cover plate 455 until the adhesive (i.e., glue) layer 459 dries. An adhesive layer 459 is preferred to prevent noises due to rattling and vibration.

FIG. 20 is a schematic view of an illustrative cover plate 455 having one or more fasteners 456A formed thereon. The one or more fasteners 456A can be injection molded on the cover plate 455 or otherwise attached thereto. Other ways to fasten the cover plate 455 to the reinforcement member 450 can be easily conceived, including the use of “Christmas tree” type fasteners which are commonly used to attach the trim panel to the door structure. These fasteners can also be injection molded on the cover plate 455 to provide a higher degree of component integration and reduce assembly time.

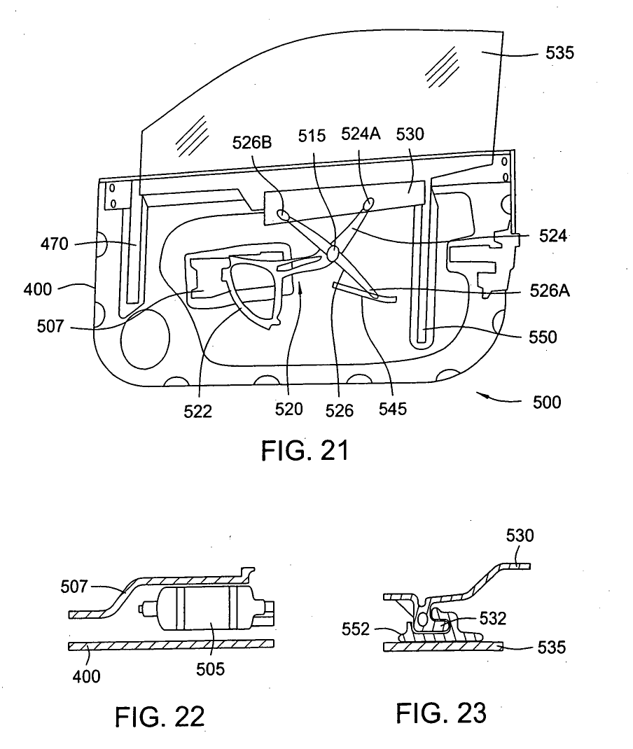

FIGS. 21, 22 and 23 show illustrative window lift systems 500 that can be used with the integrated the core module 400. In at least one embodiment, the window lift system 500 includes a motor housing 507, cross arm lifter 520, regulator 530, and window tracks 545, 550. The cross arm lifter 520 includes a gear or toothed member 522, a first extension member 524, and a second extension member 526.

A lift motor 505 can be attached to the core module 400 as shown in FIG. 22. The motor 505 can attached either on the interior or the exterior side of the core module 400. The motor housing or receptacle 507 can be injection molded on either side of the core module 400, and the motor 505 can be easily mounted on or assembled to the integrally formed motor housing 507 using a snap connection, rivet, adhesive, screw, or by any other fastener for connecting components (not shown).

Referring to FIGS. 21 and 22, the motor 505 drives the toothed member 522 about a pivot point 515 in either a clockwise or counterclockwise direction. The toothed member 522 is attached to or is integral with the first extension member 524. The first extension member 524 has a first end 524A that is attached to the regulator 530. The regulator 530 is attached to the bottom of the window glass 535. At least a portion of the regulator 530 is configured to fit within the integrally formed track 550. The track 550 is integrally formed with the core module 400 via injection molding using one or more of mono material molding, 2-K molding, in-mould labeling, and insert molding techniques, as explained above. The regulator 530 and the window track 550 can each be formed to have mating profiles 532, 552 that when engaged, the regulator 530 is guided along the profile 552 of the track 550 as shown in FIG. 23.

The first extension member 524 is pivotally connected at pivot point 515 to the second extension member 526. A first end 526A of the second extension member 526 communicates with the track 545. A second end 526B of the second extension member 526 is attached to the regulator 530. The track 545 can be integrally formed with the core module 400 via injection molding or the track 545 can be a separate part, such as a rail like member that is attached to the core module 400 or insert molded into the core. As the motor 505 drives the toothed member 522, the extension members 524 and 526 work together via the pivot point 515 to raise or lower the regulator 530 and hence, the window glass 535. The window glass 535 is supported by the regulator 530 and the glass run channel 323.

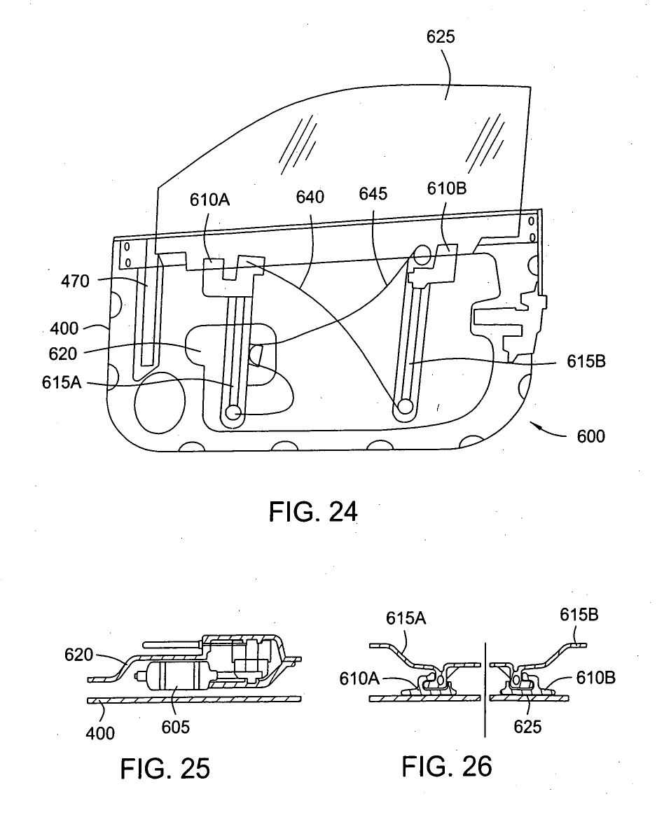

FIGS. 24, 25 and 26 show schematic views of another embodiment of a window lift system 600. FIG. 24 is a simplified schematic view of the core module 400 having the window lift system 600. The window lift system 600 includes a motor housing 620 and two or more regulators (610A and 610B), each configured on a track member 615A, 615B. A motor 605 is attached to the motor housing 620 on the core module 400 as shown in FIG. 25. The motor housing 620 can be formed on either the interior or exterior side of the core module 400. Preferably, the motor housing or receptacle 620 is injection molded on the core module 400. The motor 605 can be easily mounted on or assembled to the integrally formed motor housing 620 using a clip snap connection, rivet, screw, adhesive, or by any other fastener (not shown).

The window 625 is secured to the regulators 610A, 610B by one or more fasteners and/or adhesive type material (not shown). The regulators 610A, 610B and the window tracks 615A, 615B can each be formed to have mating profiles that when engaged the regulator is guided along the profile of its respective track as shown in FIG. 26.

The window lift system 600 further includes one or more Bowden cables (two are shown 640 and 645 in FIG. 24). The cables 640 and 645 are connected to the regulators 610A, 610B. The regulators 610A, 610B move the window 625 up or down when the motor 620 alternately draws the cables 640 and 645. The window 625 is supported by the regulators 610A, 610B in communication with the tracks 615A and 615B. These tracks can be integrally formed, insert molded onto the core module 400 or assembled onto the core module 400.

### Materials

The components described, including the door structure 300, outer core module 325, core module 400, window trim module 525 and trim panel 700, can be made from any material having the requisite properties, such as stiffness and strength for example. Suitable materials include, but are not limited to, propylene homopolymers, propylene copolymers, ethylene homopolymers, ethylene copolymers, and or any one or more of the following polymer resins:
a) polyamide resins such as nylon 6 (N6), nylon 66 (N66), nylon 46 (N46), nylon 11 (N11), nylon 12 (N12), nylon 610 (N610), nylon 612 (N612), nylon 6/66 copolymer (N6/66), nylon Jun. 66, 19610 (N6/66/610), nylon MXD6 (MXD6), nylon 6T (N6T), nylon 6/6T copolymer, nylon 66/PP copolymer, nylon 66/PPS copolymer;
b) polyester resins such as polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer and other aromatic polyesters;
c) polynitrile resins such as polyacrylonitrile (PAN), polymethacrylonitrile, acrylonitrile-styrene copolymers (AS), methacrylonitrile-styrene copolymers, methacrylonitrile-styrene-butadiene copolymers; and acrylonitrile-butadiene-styrene (ABS);
d) polymethacrylate resins such as polymethyl methacrylate and polyethylacrylate;
e) cellulose resins such as cellulose acetate and cellulose acetate butyrate;
f) fluorine resins such as polyvinylidene fluoride (PVDF), polyvinyl fluoride (PVF), polychlorofluoroethylene (PCTFE), and tetrafluoroethylene/ethylene copolymer (ETFE);
g) polyimide resins such as aromatic polyimides;
h) polysulfones;
i) polyacetals;
j) polyactones;
k) polyphenylene oxides and polyphenylene sulfides;
l) styrene-maleic anhydrides;
m) aromatic polyketones,
n) polycarbonates (PC);
o) elastomers such as ethylene-propylene rubber (EPR), ethylene propylene-diene monomer rubber (EPDM), styrenic block copolymers (SBC), polyisobutylene (PIB), butyl rubber, neoprene rubber, halobutyl rubber and the like); and
p) mixtures of any and all of a) through o) inclusive.

In one or more embodiments above or elsewhere herein, the material can include one or more fillers for added strength. Fillers can be present in an amount of from 0.001 wt % to 50 wt % in one embodiment based upon the weight of the composition and from 0.01 wt % to 25 wt % in another embodiment, and from 0.2 wt % to 10 wt % in yet another embodiment. Desirable fillers include but are not limited to titanium dioxide, silicon carbide, silica (and other oxides of silica, precipitated or not), antimony oxide, lead carbonate, zinc white, lithopone, zircon, corundum, spinel, apatite, Barytes powder, barium sulfate, magnesiter, carbon black, dolomite, calcium carbonate, sand, glass beads, mineral aggregates, talc, and hydrotalcite compounds of the ions Mg, Ca, or Zn with Al, Cr, or Fe and CO₃ and/or HPO₄, hydrated or not; quartz powder, hydrochloric magnesium carbonate, short glass fiber, long glass fiber, glass fibers, polyethylene terephthalate fibers, wollastonite, mica, carbon, fiber, nanoclays, nanocomposites, magnesium hydroxide sulfate trihydrate, clays, alumina, and other metal oxides and carbonates, metal hydroxides, chrome, phosphorous and brominated flame retardants, antimony trioxide, silicone, and any combination and blends thereof. Other illustrative fillers can include one or more polypropylene fibers, polyamide fibers, para-aramide fibers (e.g., Kevlar or Twaron), meta-aramide fibers (e.g., Nomex), polyethylene fibers (e.g., Dyneema), and combinations thereof.

The material can also include a nanocomposite, which is a blend of polymer with one or more organo-clays. Illustrative organo-clays can include one or more of ammonium, primary alkylammonium, secondary alkylammonium, tertiary alkylammonium, quaternary alkylammonium, phosphonium derivatives of aliphatic, aromatic or arylaliphatic amines, phosphines or sulfides or sulfonium derivatives of aliphatic, aromatic or arylaliphatic amines, phosphines or sulfides. Further, the organo-clay can be selected from one or more of montmorillonite, sodium montmorillonite, calcium montmorillonite, magnesium montmorillonite, nontronite, beidellite, volkonskoite, laponite, hectorite, saponite, sauconite, magadite, kenyaite, sobockite, svindordite, stevensite, vermiculite, halloysite, aluminate oxides, hydrotalcite, illite, rectorite, tarosovite, ledikite and/or florine mica.

When present, the organo-clay is preferably included in the nanocomposite at from 0.1 to 50 wt %, based on the total weight of the nanocomposite. The stabilization functionality may be selected from one or more of phenols, ketones, hindered amines, substituted phenols, substituted ketones, substituted hindered amines, and combinations thereof. The nanocomposite can further comprise at least one elastomeric ethylene-propylene copolymer, typically present in the nanocomposite at from 1 to 70 wt %, based on the total weight of the nanocomposite.

For areas, sections, or components of the door system 300 that need to provide structure, a reinforced polypropylene (PP) is preferred. Most preferred is a PP reinforced with a PET fiber or any other material that is light weight and provides a good balance of stiffness, impact strength, and has a low coefficient of linear thermal expansion (CLTE).

In one or more embodiments above or elsewhere herein, the polymer can be impact modified to provide improved impact resistance. Impact modifiers include, but are not limited to plastomers, ethylene propylene rubber (EPR), ethylene-propylene diene monomer rubber (EPDM), and may be used in combination with compatibilizers like, but not limited to maleated polypropylene, maleated polyethylene and other maleated polymers, hydroxilated polypropylene and other hydroxilated polymers, derivatives thereof, and any combination thereof.

In another embodiment, the material can contain a plastomer, preferably a propylene plastomer blend. The term “plastomer” as used herein refers to one or more polyolefin polymers and/or copolymers having a density of from 0.85 g/cm³ to 0.915 g/cm³ according to ASTM D-4703 Method B or ASTM D-1505, and a melt index (MI) between 0.10 dg/min and 30 dg/min according to ASTM D-1238 at 190° C., 2.1 kg). Preferred plastomers have a melt index (MI) of between 0.10 dg/min and 20 dg/min in one embodiment, and from 0.2 dg/min to 10 dg/min in another embodiment, and from 0.3 dg/min to 8 dg/min in yet another embodiment as measured by ASTM D-1238. Preferred plastomers can have an average molecular weight of from 10,000 to 800,000 in one embodiment, and from 20,000 to 700,000 in another embodiment. The molecular weight distribution (Mw/Mn) of desirable plastomers ranges from 1.5 to 5 in one embodiment, and from 2.0 to 4 in another embodiment. The 1% secant flexural modulus (ASTM D-790) of preferred plastomers range from 10 MPa to 150 MPa in one embodiment, and from 20 MPa to 100 MPa in another embodiment. Further, a preferred plastomer has a melting temperature (Tm) of from 30° C. to 80° C. (first melt peak) and from 50° C. to 125° C. (second melt peak) in one embodiment, and from 40° C. to 70° C. (first melt peak) and from 50° C. to 100° C. (second melt peak) in another embodiment.

In one or more embodiments above or elsewhere herein, the plastomer can be a copolymer of ethylene derived units and at least one of a C3 to C10 α-olefin derived units. Preferably, the copolymer has a density less than 0.915 g/cm³. The amount of comonomer (C3 to C10 α-olefin derived units) present in the plastomer ranges from 2 wt % to 35 wt % in one embodiment, and from 5 wt % to 30 wt % in another embodiment, and from 15 wt % to 25 wt % in yet another embodiment, and from 20 wt % to 30 wt % in yet another embodiment.

In one or more embodiments above or elsewhere herein, the plastomer can be one or more metallocene catalyzed copolymers of ethylene derived units and higher α-olefin derived units, such as propylene, 1-butene, 1-hexene and 1-octene. Preferably, the plastomer contains enough of one or more of those comonomer units to yield a density between 0.860 g/cm³ and 0.900 g/cm³. Examples of commercially available plastomers include: EXACT 4150, a copolymer of ethylene and 1-hexene, the 1-hexene derived units making up from 18 wt % to 22 wt % of the plastomer and having a density of 0.895 g/cm³ and MI of 3.5 dg/min (available from ExxonMobil Chemical Company); and EXACT 8201, a copolymer of ethylene and 1-octene, the 1-octene derived units making up from 26 wt % to 30 wt % of the plastomer, and having a density of 0.882 g/cm³ and MI of 1.0 dg/min (available from ExxonMobil Chemical Company).

Preferred blends for use as the molded material herein typically include of from about 15%, 20% or 25% to about 80%, 90% or 100% polymer by weight; optionally of from about 0%, 5%, or 10% to about 35%, 40%, or 50% filler by weight, and optionally of from about 0%, 5%, or 10% to about 35%, 40%, or 50% plastomer by weight. In one or more embodiments, a preferred blend contains one or more polymers described in an amount ranging from a low of about 15%, 20% or 25% to a high of about 80%, 90% or 100% polymer by weight. In one or more embodiments, a preferred blend contains at least about 1%, 5%, 10%, 15%, or 20% plastomer by weight. In one or more embodiments, a preferred blend contains at least about 1%, 5%, 10%, 15%, or 20% filler by weight.

Preferably, blends for use herein will have a tensile strength of at least 6,500 MPa, at least 7,500 MPa, or at least 9,000 MPa. Further, preferred blends will have a flexural modulus of 1,750 MPa or more, such as about 1,800 MPa or more, or more than about 2,000 MPa.

In addition to the materials and polymers described above, one or more thermoplastic vulcanizates (TPV), thermoplastic elastomer (TPE), thermoplastic olefin (TPO), polyurethanes (PU), or elastomers such as EPR or EPDM can be used for areas or components that need to have sealing properties. Those material can be used in dense (non-foamed) or in foamed state. Most preferably, a TPV is selected due to the inherent mechanical properties that provide excellent sealing capability and the ability to be injection molded. The other aspect of materials will be the compatibalization of the structural and sealing materials, or the ability to adhere to each other. The materials of either the structural and/or sealing systems can be functionalized or have a secondary additive or component added to the material to provided good bondability.

### Assembly Sequence

Referring again to FIG. 3, the door system can be easily assembled. In at least one specific embodiment, the door system can be assembled according to the following sequence. First, the desired components are inserted into an injection mold for making the core module 400. The core module 400 and the inserted components are injection molded with a first material. A second material, such as polypropylene, polyethylene and/or a thermoplastic vulcanizate (TPV), can be injection molded to create the flexible components (seals, plugs, grommets, or soft touch portions of the skin) on the core module 400. Gas or water assist can also be used to create hollow profiles where needed for additional structure strength. Foaming agents can also be used to minimize sink marks or to create a foam structure for increased stiffness. The core module 400 having the integrated components formed thereon is ejected from the tool. The components that have not yet been integrated to the core module 400 are then assembled. The window glass 535 is assembled to the core module 400. The window trim module 525 and the outer core module 325 are now assembled to the core module 400. The window glass 535 is then properly adjusted, if needed. That competed core sub-assembly can now be tested functionally, and is ready for delivery to the assembly line.

At the assembly line, the completed core sub-assembly is attached to the door structure 300, the trim panel 700 is attached to the assembly, and then all connections between the core 400 and the door structure 300 (mechanical, electrical or other) are made. Alternatively, the trim panel 700 can be attached to the completed core sub-assembly which is then attached to the door structure 300. The door assembly is then ready to be assembled to the vehicle.

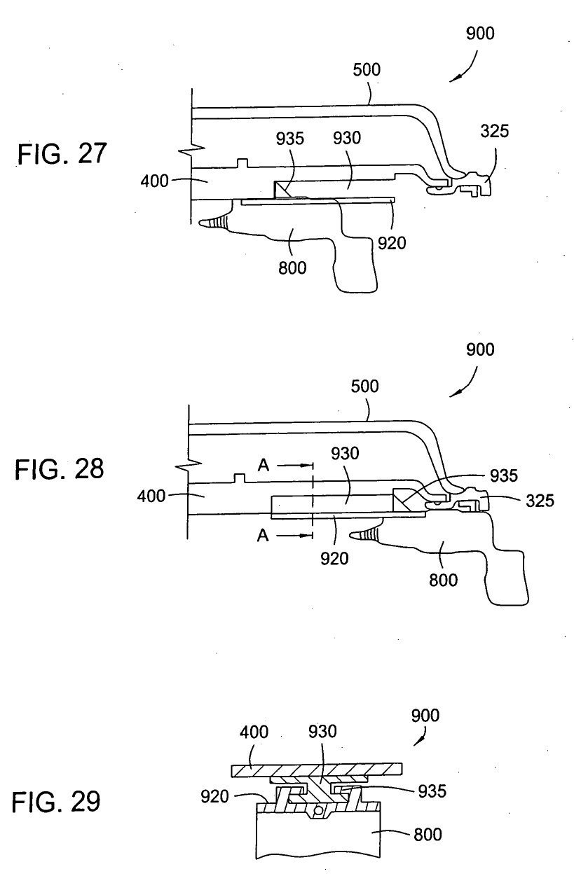

FIGS. 27, 28 and 29 show illustrative partial cross sectional views of one embodiment of a door assembly utilizing a sliding lock assembly 900 to facilitate assembly. The sliding lock assembly 900 allows the lock to be in a first (“retracted”) position during transport and mounting of the core module 400 to the door structure 300. Then, the lock assembly 900 can be actuated or moved into a second (“assembled”) position.

FIG. 27 shows an illustrative side view of the sliding lock assembly 900 in a pre-assembled or retracted position. FIG. 28 shows an illustrative side view of the sliding lock assembly 900 in the assembled position. FIG. 29 is a partial cross section along lines A-A of FIG. 28.

Referring to FIG. 27, the locking mechanism 800 is connected or otherwise affixed to a sliding mechanism 920 (i.e., sled or slider) which allows the lock mechanism 800 to move during the assembly of the core module 400 to the door structure 300. Preferably, the sliding mechanism 920 is adapted to move laterally within a single plane although it is envisioned that the sliding mechanism 920 can be adapted to move laterally in two horizontal planes, e.g., along an X-axis and along a Y-axis. At least a portion of the lock mechanism 800 can be attached to the sliding mechanism 920 by being adhered, welded, screwed, bolted, riveted, clipped, or otherwise attached using any known technique. The sliding mechanism 920 can also be an integral part of the lock mechanism 800, if desired.

As shown in FIG. 29, the core module 400 can include a rail or track system 930 attached or integrally formed on at least a portion of the outer surface thereof. The sliding mechanism 920 can also include a track or rail system 935 that has a mating profile to engage the profile of the track system 930 of the core module 400. The sliding mechanism 920 allows the lock mechanism 800 to be moved from a retracted or first position shown in FIG. 27 to a second or assembled position shown in FIG. 28 after the core module 400 is attached to the door structure 300.

In one or more embodiments, a tool (not shown) can be used to move the lock mechanism 800 from the first position to the second. For example, a simple tool can be inserted through the hole where the lock mechanism 800 would contact the door structure 300. The tool could be adapted to engage the lock mechanism 800 and used to manipulate (i.e., pull) the lock mechanism 800 into the second or assembled position where the lock mechanism 800 can be mounted to the door structure 300.

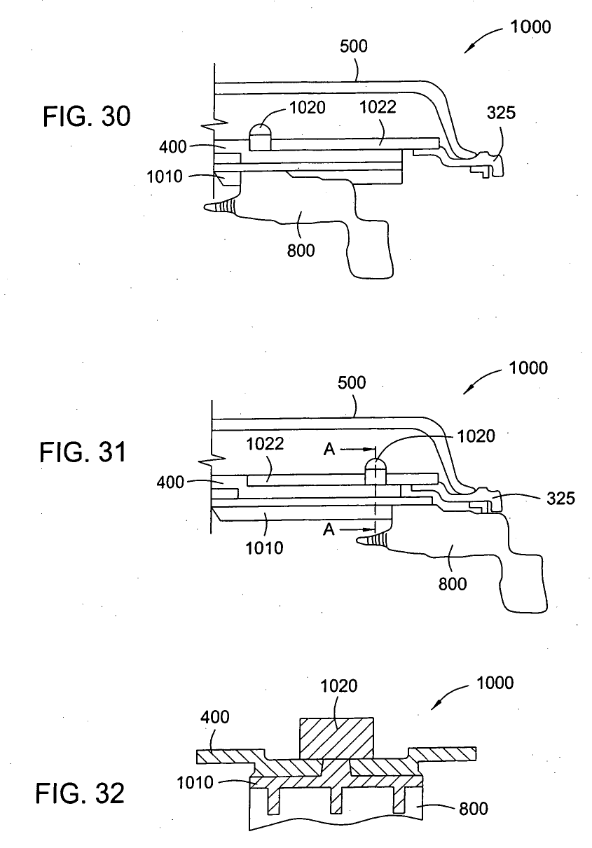

FIGS. 30, 31, and 32 show illustrative side views of a door assembly utilizing another embodiment of a sliding lock assembly 1000 to facilitate assembly. In particular, FIG. 30 shows a schematic side view of the sliding lock assembly 1000 in a first or pre-assembled position. FIG. 31 shows a schematic side view of the sliding lock assembly 1000 in an assembled or second position. FIG. 32 is a partial cross section along lines A-A of FIG. 31.

Referring to FIGS. 30-32, the sliding lock assembly 1000 includes a sliding mechanism 1010 in communication with a handle or lever 1020 for manipulating the lock mechanism 800. The sliding mechanism 1010 and the handle 1020 can be injection molded within a portion of the core module 400. Preferably, the handle 1020 is formed within a recess 1022 formed in an upper surface of the core module 400 as shown in FIGS. 30 and 31. The handle 1020 can be injection molded as one piece with the sliding mechanism 1010 as shown in cross section in FIG. 32. Preferably, the sliding mechanism 1010 is connected to the lock mechanism 800 using one or more legs or anchors 1010A (three are shown) at least partially disposed within the lock mechanism 800 as shown in FIG. 32.

The operation of the lock assembly 1000 is similar to that described above with reference to FIGS. 27-29 except that the handle 1020 can be used to manipulate the sliding mechanism 1010 and hence the lock mechanism 800. Of course, a tool (not shown) could also be used, if needed, to help move the sliding mechanism 1010 from the first position shown in FIG. 30 to the second position shown in FIG. 31.

As noted above, the degree of integration described can dramatically reduce the cost and assembly complexity of the finished door. Assembly errors are also reduced if not eliminated. Functional testing costs after final assembly are also reduced or eliminated because a majority of the functionality can be tested prior to final assembly (i.e., pre-tested). Further, the use of plastic materials in the door assembly can provide lower overall weight, more part integration, improved noise insulation, greater design freedom and will enable cheaper design modifications (i.e., using replaceable inserts in an injection molding tool).

Furthermore, the described placement of the reinforcement section and the seal systems allows for easy installation and assembly of the door system. In particular, the placement of the reinforcement section and the seal system provides easy access to the numerous components of the door including the window and window lift system. Such placement also allows the working components, most notably the window lift system, of the door to be functionality tested before final installation of the door to the vehicle. As such, valuable time and logistic concerns are greatly reduced.

In addition, the door system provided reduces the number of individual components (i.e., parts) and assembly steps required to produce the finished door. The integration of the reinforcement section alone makes part assembly easier, reduces weight of the door and allows functionality testing of the various assembled components and parts. Further, the integrated parts can be positioned correctly and therefore, are less subjected to human error or omission.

In another embodiment, this invention relates to:

1. A door system, comprising:

a door structure;

a body comprising one or more components disposed thereon;

a first module having an upper cavity and a lower cavity, the upper cavity adapted to at least partially surround a first side of a window glass and the lower cavity adapted to at least partially engage the body;

a second module adapted to at least partially surround a second side of the window glass and adapted to at least partially contact the upper cavity of the first module; and

a trim module adapted to at least partially cover the core module.

### 2. The door system of paragraph 1, wherein the body comprises one or more reinforcement members disposed on a first side thereof.

### 3. The door system of paragraph 1 or 2, wherein the body further comprises a glass run channel at least disposed on a second side thereof

### 4. The door system of paragraph 3, wherein the glass run channel at least disposed on the second side of the body comprises an open profile.

### 5. The door system of paragraph 1, 2, 3, or 4, wherein the one or more components are injection molded on the body.

### 6. The door system of any of paragraphs 1 to 5, wherein the body comprises one or more seals disposed thereon.

### 7. The door system of paragraph 6, wherein the one or more seals are injection molded on the body.

### 8. The door system of paragraph 2, 3, 4, 5, 6, or 7 wherein the reinforcement member comprises a first flange and a second flange, each adapted to contact the first side of the body.

### 9. The door system of paragraph 2, 3, 4, 5, 6, 7, or 8 wherein the reinforcement member comprises a first flange, a second flange and a recessed portion between the flanges.

### 10. The door system of any of paragraphs 2 to 9, wherein the reinforcement member further comprises an insert disposed therein, the insert comprising one or more stiffening members.

### 11. The door system of any of paragraphs 2 to 10, wherein the reinforcement member further comprises a cover plate disposed thereon to define a hollow cavity between the reinforcement member and the cover plate.

12. The door system of any of paragraphs 1 to 11, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

### 13. The door system of any of paragraphs 6 to 12, wherein the one or more seals comprises a glass run channel seal, beltline seal, lower sash seal, core to frame seal, or combinations thereof.

### 14. The door system of any of paragraphs 1 to 13, wherein the one or more components are integrally formed on the body.

### 15. The door system of any of paragraphs 1 to 14, wherein the one or more components comprise a window regulator, window track, impact bolster, air channel, window motor housing, map pocket, speaker box, plug, grommet, or combinations thereof.

### 16. The door system of any of paragraphs 1 to 15, wherein the body comprises polypropylene.

### 17. The door system of any of paragraphs 1 to 16, wherein the body is injection molded from polypropylene.

### 18. The door system of any of paragraphs 1 to 17, wherein the body comprises one or more engineering resins.

### 19. The door system of any of paragraphs 1 to 18, wherein the body is injection molded from one or more engineering resins.

20. The door system of any of paragraphs 1 to 19, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
21. The door system of any of paragraphs 1 to 20, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

### 22. The door system of any of paragraphs 1 to 21, wherein the first module is adapted to be assembled on the door structure.

### 23. The door system of any of paragraphs 1 to 22, wherein the second module is adapted to be assembled on an upper portion of the core module and in contact with at least a portion of the first module.

### 24. The door system of any of paragraphs 1 to 23, wherein the body is adapted to cover the lower cavity of the first module.

### 25. The door system of any of paragraphs 1 to 24, further comprising a wet/dry barrier disposed on the second module and the body.

26. A door system, comprising:

a door structure;

at least one window glass;

a first module having one or more components disposed thereon, the first module comprising:

a body having a first and second side;

a reinforcement member disposed on the first side of the body; and

a glass run channel disposed on the second side of the body, the glass run channel having an open profile;

a second module having an upper cavity and a lower cavity, the upper cavity adapted to at least partially surround a first side of the window glass and the lower cavity adapted to at least partially engage the first module;

a third module adapted to at least partially surround a second side of the window glass and adapted to at least partially contact the upper cavity of the second module; and

a trim panel adapted to cover the first module.

### 27. The door system of paragraph 26 wherein the first side of the body faces an interior compartment of a vehicle.

### 28. The door system of paragraph 26 or 27, wherein the glass run channel extends at least beyond a beltline of the body.

### 29. The door system of paragraph 26, 27, or 28, wherein the glass run channel at least disposed on the second side of the body comprises an open profile.

### 30. The door system of any of paragraphs 26 to 29, wherein the one or more components are injection molded on the body.

### 31. The door system of any of paragraphs 26 to 30, wherein the body comprises one or more seals disposed thereon.

### 32. The door system of paragraph 31, wherein the one or more seals are injection molded on the body.

### 33. The door system of any of paragraphs 26 to 32, wherein the reinforcement member comprises a first flange and a second flange, each adapted to contact the first side of the body.

### 34. The door system of any of paragraphs 26 to 33, wherein the reinforcement member comprises a first flange, a second flange and a recessed portion between the flanges.

### 35. The door system of paragraph 34, wherein the reinforcement member further comprises an insert disposed therein, the insert comprising one or more stiffening members.

### 36. The door system of paragraph 35, wherein the reinforcement member further comprises a cover plate disposed thereon to define a hollow cavity between the reinforcement member and the cover plate.

37. The door system of any of paragraphs 26 to 36, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

### 38. The door system of paragraph 31, wherein the one or more seals comprises a glass run channel seal, beltline seal, lower sash seal, core to frame seal, or combinations thereof.

### 39. The door system of any of paragraphs 26 to 38, wherein at least one of the one or more components are injection molded on the body.

### 40. The door system of any of paragraphs 26 to 39, wherein the one or more components comprise a window regulator, window track, impact bolster, air channel, window motor housing, map pocket, speaker box, plug, grommet, or combinations thereof.

### 41. The door system of any of paragraphs 26 to 40, wherein the body comprises polypropylene.

### 42. The door system of any of paragraphs 26 to 41, wherein the body is injection molded from polypropylene.

### 43. The door system of any of paragraphs 26 to 42, wherein the body comprises one or more engineering resins.

### 44. The door system of any of paragraphs 26 to 43, wherein the body is injection molded from one or more engineering resins.

45. The door system of any of paragraphs 26 to 44, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
46. The door system of any of paragraphs 26 to 45, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

### 47. The door system of any of paragraphs 26 to 46, wherein the second module is adapted to be assembled on the door structure.

### 48. The door system of any of paragraphs 26 to 47, wherein the third module is adapted to be assembled on an upper portion of the first module and in contact with at least a portion of the second module.

### 49. The door system of any of paragraphs 26 to 48, wherein the body is adapted to cover the lower cavity of the second module.

### 50. The door system of any of paragraphs 26 to 49, further comprising a wet/dry barrier adapted to cover the second and third modules.

### 51. The door system of any of paragraphs 26 to 50, wherein one or more window tracks are injection molded on the second side of the body.

### 52. The door system of any of paragraphs 26 to 51, wherein one or more impact bolsters are injection molded on the first side of the body.

### 53. The door system of any of paragraphs 26 to 52, wherein the window glass slides between the first module and the second module.

54. A door system, comprising:

a door structure;

at least one window glass;

a first module having one or more components disposed thereon, the first module comprising:

a body having a first and second side;

a reinforcement member disposed on the first side of the body; and

a glass run channel disposed on the second side of the body, the glass run channel having an open profile;

a second module adapted to surround an inner surface of the door structure, the second module having an annular body with a support member disposed therethrough thereby defining an upper cavity and a lower cavity;

a third module adapted to at least partially surround a second side of the window glass and adapted to at least partially contact the upper cavity of the second module; and

a trim panel adapted to cover the first module.

### 55. The door system of paragraph 54, wherein the glass run channel extends at least beyond a beltline of the first module.

### 56. The door system of paragraph 54 or 55, wherein the glass run channel at least disposed on the second side of the first module comprises an open profile.

### 57. The door system of paragraph 54, 55, or 56, wherein the one or more components are injection molded on the first module.

### 58. The door system of paragraph 54, 55, 56, or 57 wherein the first module comprises one or more seals disposed thereon.

### 59. The door system of any of paragraphs 54 to 58, wherein the one or more seals are injection molded on the first module.

### 60. The door system of any of paragraphs 54 to 59, wherein the reinforcement member comprises a first flange and a second flange, each adapted to contact the first side of the first module.

### 61. The door system of any of paragraphs 54 to 60, wherein the reinforcement member comprises a first flange, a second flange and a recessed portion between the flanges.

### 62. The door system of paragraph 61, wherein the reinforcement member further comprises an insert disposed therein, the insert comprising one or more stiffening members.

### 63. The door system of paragraph 62, wherein the reinforcement member further comprises a cover plate disposed thereon to define a hollow cavity between the reinforcement member and the cover plate.

64. The door system of any of paragraphs 54 to 63, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

### 65. The door system of paragraph 64, wherein at least one of the one or more components is injection molded on the first module.

### 66. The door system of any of paragraphs 54 to 65, wherein the one or more components comprise a window regulator, window track, impact bolster, air channel, window motor housing, map pocket, speaker box, plug, grommet, or combinations thereof.

### 67. The door system of any of paragraphs 54 to 66, wherein the second module comprises polypropylene.

### 68. The door system of any of paragraphs 54 to 67, wherein the second module is injection molded from polypropylene.

### 69. The door system of any of paragraphs 54 to 68, wherein the second module comprises one or more engineering resins.

### 70. The door system of any of paragraphs 54 to 69, wherein the second module is injection molded from one or more engineering resins.

71. The door system of any of paragraphs 54 to 70, wherein the second module comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.
72. The door system of any of paragraphs 54 to 71, wherein the second module is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

### 73. The door system of any of paragraphs 54 to 72, wherein the second module is adapted to be assembled on the door structure.

### 74. The door system of any of paragraphs 54 to 73, wherein the third module is adapted to be assembled on an upper portion of the first module and in contact with at least a portion of the second module.

### 75. The door system of any of paragraphs 54 to 74, wherein the first module is adapted to cover the lower cavity of the second module.

### 76. The door system of any of paragraphs 54 to 75, wherein one or more window tracks are injection molded on the second side of the first module.

### 77. The door system of any of paragraphs 54 to 76, wherein one or more impact bolsters are injection molded on the first side of the first module.

### 78. The door system of any of paragraphs 54 to 77, wherein the window glass slides between the first module and the second module.

One of ordinary skill in the art will recognize that the door system described can be utilized as a complete system, or the individual components thereof can be utilized separately as individual mini-systems or modular type units to help consolidate two or more components if desired.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents, including priority documents, cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A door system, comprising:
a door structure;
a body comprising one or more components disposed thereon;
a first module having an upper cavity and a lower cavity, the upper cavity adapted to at least partially surround a first side of a window glass and the lower cavity adapted to at least partially engage the body;
a second module adapted to at least partially surround a second side of the window glass and adapted to at least partially contact the upper cavity of the first module; and
a trim module adapted to at least partially cover the core module.

2. The door system of claim 1, wherein the body comprises one or more reinforcement members disposed on a first side thereof.

3. The door system of claim 2, wherein the body further comprises a glass run channel at least disposed on a second side thereof

4. The door system of claim 3, wherein the glass run channel at least disposed on the second side of the body comprises an open profile.

5. The door system of claim 1, wherein the one or more components are injection molded on the body.

6. The door system of claim 1, wherein the body comprises one or more seals disposed thereon.

7. The door system of claim 6, wherein the one or more seals are injection molded on the body.

8. The door system of claim 2, wherein the reinforcement member comprises a first flange and a second flange, each adapted to contact the first side of the body.

9. The door system of claim 2, wherein the reinforcement member comprises a first flange, a second flange and a recessed portion between the flanges.

10. The door system of claim 2, wherein the reinforcement member further comprises an insert disposed therein, the insert comprising one or more stiffening members.

11. The door system of claim 10, wherein the reinforcement member further comprises a cover plate disposed thereon to define a hollow cavity between the reinforcement member and the cover plate.

12. The door system of claim 1, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

13. The door system of claim 6, wherein the one or more seals comprises a glass run channel seal, beltline seal, lower sash seal, core to frame seal, or combinations thereof.

14. The door system of claim 1, wherein the one or more components are integrally formed on the body.

15. The door system of claim 1, wherein the one or more components comprise a window regulator, window track, impact bolster, air channel, window motor housing, map pocket, speaker box, plug, grommet, or combinations thereof.

16. The door system of claim 1, wherein the body comprises polypropylene.

17. The door system of claim 1, wherein the body is injection molded from polypropylene.

18. The door system of claim 1, wherein the body comprises one or more engineering resins.

19. The door system of claim 1, wherein the body is injection molded from one or more engineering resins.

20. The door system of claim 1, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

21. The door system of claim 1, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

22. The door system of claim 1, wherein the first module is adapted to be assembled on the door structure.

23. The door system of claim 1, wherein the second module is adapted to be assembled on an upper portion of the core module and in contact with at least a portion of the first module.

24. The door system of claim 1, wherein the body is adapted to cover the lower cavity of the first module.

25. The door system of claim 1, further comprising a wet/dry barrier disposed on the second module and the body.

26. A door system, comprising:
a door structure;
at least one window glass;
a first module having one or more components disposed thereon, the first module comprising:
a body having a first and second side;
a reinforcement member disposed on the first side of the body; and
a glass run channel disposed on the second side of the body, the glass run channel having an open profile;
a second module having an upper cavity and a lower cavity, the upper cavity adapted to at least partially surround a first side of the window glass and the lower cavity adapted to at least partially engage the first module;
a third module adapted to at least partially surround a second side of the window glass and adapted to at least partially contact the upper cavity of the second module; and
a trim panel adapted to cover the first module.

27. The door system of claim 26 wherein the first side of the body faces an interior compartment of a vehicle.

28. The door system of claim 26, wherein the glass run channel extends at least beyond a beltline of the body.

29. The door system of claim 26, wherein the glass run channel at least disposed on the second side of the body comprises an open profile.

30. The door system of claim 26, wherein the one or more components are injection molded on the body.

31. The door system of claim 26, wherein the body comprises one or more seals disposed thereon.

32. The door system of claim 31, wherein the one or more seals are injection molded on the body.

33. The door system of claim 26, wherein the reinforcement member comprises a first flange and a second flange, each adapted to contact the first side of the body.

34. The door system of claim 26, wherein the reinforcement member comprises a first flange, a second flange and a recessed portion between the flanges.

35. The door system of claim 34, wherein the reinforcement member further comprises an insert disposed therein, the insert comprising one or more stiffening members.

36. The door system of claim 35, wherein the reinforcement member further comprises a cover plate disposed thereon to define a hollow cavity between the reinforcement member and the cover plate.

37. The door system of claim 26, wherein the one or more components comprises a window regulator, window track, window glass, window switches, door lock, door handle, door lock switch, arm rest, map pocket, impact bolster, wire harness, speaker, window motor, outside mirror motor, plug, grommet, or combinations thereof.

38. The door system of claim 31, wherein the one or more seals comprises a glass run channel seal, beltline seal, lower sash seal, core to frame seal, or combinations thereof.

39. The door system of claim 31, wherein at least one of the one or more components are injection molded on the body.

40. The door system of claim 26, wherein the one or more components comprise a window regulator, window track, impact bolster, air channel, window motor housing, map pocket, speaker box, plug, grommet, or combinations thereof.

41. The door system of claim 26, wherein the body comprises polypropylene.

42. The door system of claim 26, wherein the body is injection molded from polypropylene.

43. The door system of claim 26, wherein the body comprises one or more engineering resins.

44. The door system of claim 26, wherein the body is injection molded from one or more engineering resins.

45. The door system of claim 26, wherein the body comprises one or more engineering resins selected from the group consisting of polyamide resins, polyester resins, polynitrile resins, polymethacrylate resins, cellulose resins, fluorine resins, polyimide resins, polysulfones, polyacetals, polyactones, polyphenylene oxides, polyphenylene sulfides, styrene-maleic anhydrides, aromatic polyketones, and polycarbonates.

46. The door system of claim 26, wherein the body is injection molded from one or more engineering resins selected from the group consisting of polybutylene terephthalate (PBT), polyethylene terephthalate (PET), polyethylene isophthalate (PEI), PET/PEI copolymer, polyacrylate (PAR), polybutylene naphthalate (PBN), liquid crystal polyester, polyoxalkylene diimide diacid/polybutyrate terephthalate copolymer. polyacrylonitrile (PAN), polymethacrylonitrile, acrylonitrile-styrene copolymers (AS), methacrylonitrile-styrene copolymers, methacrylonitrile-styrene-butadiene copolymers; acrylonitrile-butadiene-styrene (ABS), derivatives thereof, and mixtures or blends thereof.

47. The door system of claim 26, wherein the second module is adapted to be assembled on the door structure.

48. The door system of claim 26, wherein the third module is adapted to be assembled on an upper portion of the first module and in contact with at least a portion of the second module.

49. The door system of claim 26, wherein the body is adapted to cover the lower cavity of the second module.

50. The door system of claim 26, further comprising a wet/dry barrier adapted to cover the second and third modules.

51. The door system of claim 26, wherein one or more window tracks are injection molded on the second side of the body.

52. The door system of claim 26, wherein one or more impact bolsters are injection molded on the first side of the body.

53. The door system of claim 26, wherein the window glass slides between the first module and the second module.

54. A door system, comprising:
a door structure;
at least one window glass;
a first module having one or more components disposed thereon, the first module comprising:
a body having a first and second side;
a reinforcement member disposed on the first side of the body; and
a glass run channel disposed on the second side of the body, the glass run channel having an open profile;
a second module adapted to surround an inner surface of the door structure, the second module having an annular body with a support member disposed therethrough thereby defining an upper cavity and a lower cavity;
a third module adapted to at least partially surround a second side of the window glass and adapted to at least partially contact the upper cavity of the second module; and
a trim panel adapted to cover the first module.

55. The door system of claim 54, wherein the glass run channel extends at least beyond a beltline of the first module.

56. The door system of claim 54, wherein the glass run channel at least disposed on the second side of the first module comprises an open profile.

57. The door system of claim 54, wherein the one or more components are injection molded on the first module.

58. The door system of claim 54, wherein the first module comprises one or more seals disposed thereon.

59. The door system of claim 58, wherein the one or more seals are injection molded on the first module.

60. The door system of claim 54, wherein the reinforcement member comprises a first flange and a second flange, each adapted to contact the first side of the first module.
